(19) United States
(12) Patent Application Publication
(10) Pub. No.: US 2008/0291564 A1
(43) Pub. Date: Nov. 27, 2008

(54) Detecting head-disk contact during off-track operations

(75) Inventors: Yawshing Tang, Saratoga, CA (US); Carl Xiaodong Che, Saratoga, CA (US); Na-Young Kim, San Jose, CA (US); Won C. Yang, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/805,978

(22) Filed: May 25, 2007

(51) Int. Cl. G11B 21/02

(52) U.S. Cl. 360/75

(57) ABSTRACT

A disk drive that can detect contact between a head and a disk during an off-track operation such as a seek routine, a ramp load or a head take-off. The disk drive includes a circuit that causes the head to move across the disk in a seek routine. A head heater element is driven to move the head into contact with the disk. A read signal provided by the head is filtered through a band pass filter that has a center frequency. The frequency that produces the maximum signal is selected as the center frequency for the band pass filter. The drive can monitor subsequent head contact during an off-track operation by detecting output from the band pass filter.

### BACKGROUND OF THE INVENTION

1. Field of the Invention

The present invention relates to a system and method for monitoring contact between a head and a disk of a hard disk drive during an off-track operation.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

The disks are rotated by a spindle motor of the drive. Rotation of the disks creates an air flow within the disk drive. Each head has an air bearing surface that cooperates with the air flow to create an air bearing between the head and the adjacent disk surface. The air bearing eliminates or minimizes the mechanical wear between the head and the disk. The height of the air bearing is commonly referred to as the flying height of the head.

Due to various reasons the heads may make contact with the disks. This contact may cause damage to the head and/or disk. It would be desirable to monitor the system to detect head/disk contact.

Contact or near contact between the heads and disks can be determined by analyzing the read signal generated by the heads. For example, it is known that head contact or near head contact changes the temperature of the head and varies the amplitude of the read signal. For example, head contact can create frictional heat that increases the head temperature. Near contact can cause heat transfer from the head to the disk that lowers the head temperature.

Head contact can be located by determining when the read signal exceeds a certain threshold. Analyzing the read signal amplitude to determine head contact can be effective when the head is following a disk track. These techniques are less accurate when the head is not following a single track. For example, during a seek routine the head moves across the disk to a new track location. The amplitude of the read signal constantly varies as the head moves from track to track during the seek routine. It would be desirable to provide a system and method that allows for head contact detection during an off-track operation such as seeking, ramp loading or head take-off.

### BRIEF SUMMARY OF THE INVENTION

A hard disk drive with a head coupled to a disk. The head has a read element and a heater element. The disk drive includes a circuit that moves the head across the disk in a seek routine and drives the heater element to cause contact between the head and the disk. The circuit determines a center frequency of a read signal provided by the head during the seek routine that corresponds to the head contact.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical circuit for the hard disk drive;

FIG. 4 is a schematic showing function blocks of a detection circuit of the drive;

FIG. 5 is a flowchart showing process for detecting head contact;

FIG. 6 is a flowchart showing a process for detecting and monitoring head contact within the disk drive;

FIG. 7 is a flowchart of a process for setting a fly height on demand heater element current.

### DETAILED DESCRIPTION

Disclosed is a disk drive that can detect contact between a head and a disk during an off-track operation such as a seek routine, a ramp load or a head take-off. The disk drive includes a circuit that causes the head to move across the disk in a seek routine. A head heater element is driven to move the head into contact with the disk. A read signal provided by the head is filtered through a band pass filter that has a center frequency. The frequency that produces the maximum signal is selected as the center frequency for the band pass filter. The drive can monitor subsequent head contact during an off-track operation by detecting output from the band pass filter.

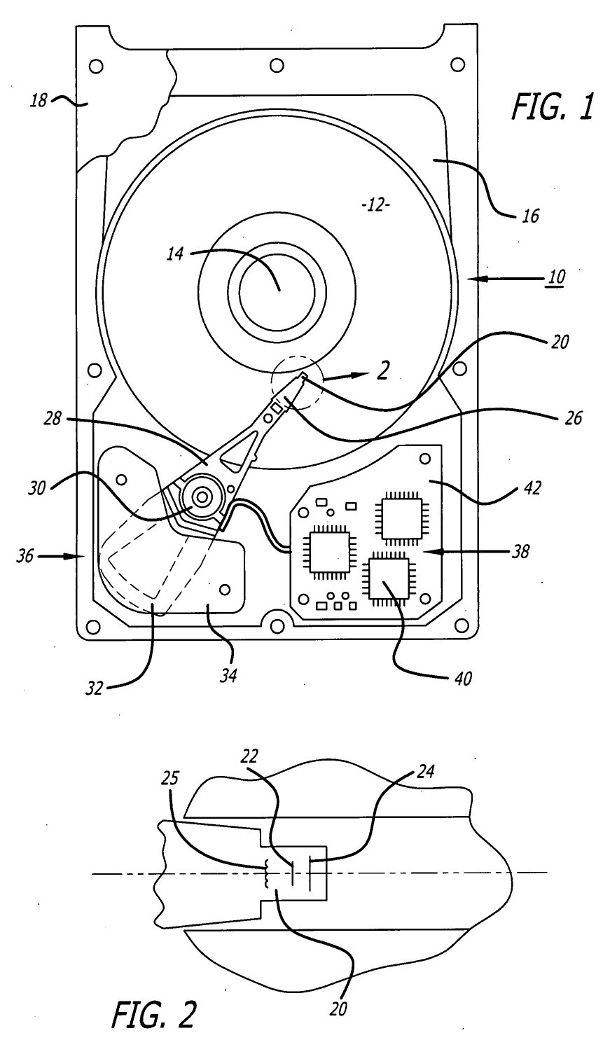

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux. The heads 20 also contain a heater element 25. The heater element 25 may be a coil of resistive material. Current can be provided to the heater element 25 to generate heat within the head 20. The heat thermally expands the head 20 and moves the read 24 and write 22 elements closer to the disk.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

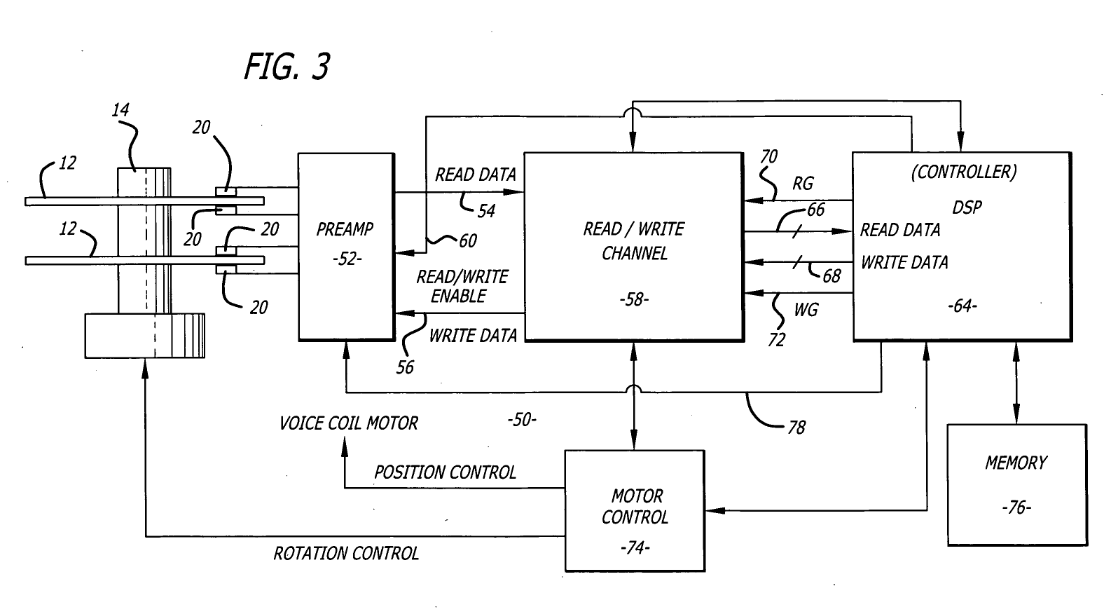

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

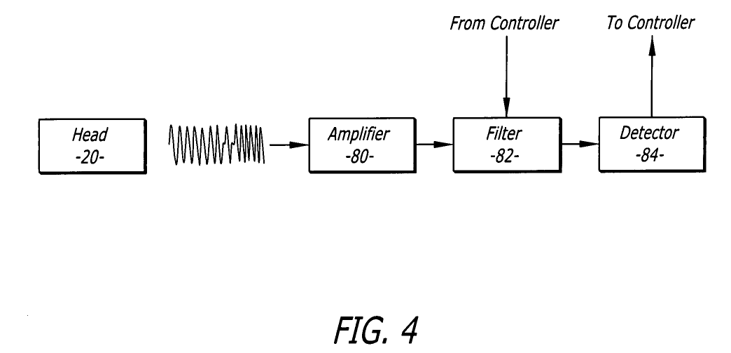

FIG. 4 is a schematic showing functional blocks of a head contact detection circuit. The detection circuit includes an amplifier 80 coupled to a head 20. The amplifier 80 adjusts the amplitude of a read signal provided by the head 20. The amplified read signal is filtered by a band-pass filter 82. The read signal is then provided to an amplitude detector 84. The amplitude detector 84 can be used to determine a head contact count.

The band-pass filter frequency can be set and adjusted by control signals from the controller. The controller can set the filter to the frequency which generates the largest amplitude. The frequency range for the read signal in a head contact event is typically between 100 and 400 KHz.

The output of the band-pass filter 82 can be provided to the controller. After the band-pass filter is set the controller can monitor the output of the filter to detect head contact. An output from the filter may be indicative of head contact. The controller may also monitor the output of the amplitude detector 84 to determine head contact. A head contact count may be defined as an output from the band-pass filter that exceeds a threshold.

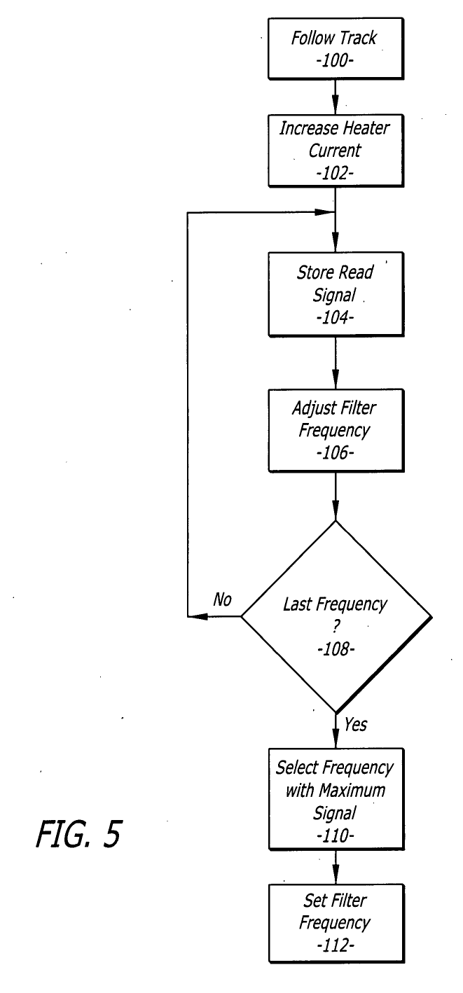

FIG. 5 shows a method for head contact detection. In step 100 the drive is set in to track following mode. In step 102, the current to the heater element is increased to move the head closer to the disk. The value of the read signal is stored in step 104 and the filter frequency is adjusted in step 106. In decision block 108 it is determined whether the process is at the last frequency setting. If so, the frequency with the highest amplitude is determined in step 110 and the filter is set at that frequency in step 112. If not, the process returns to step 104.

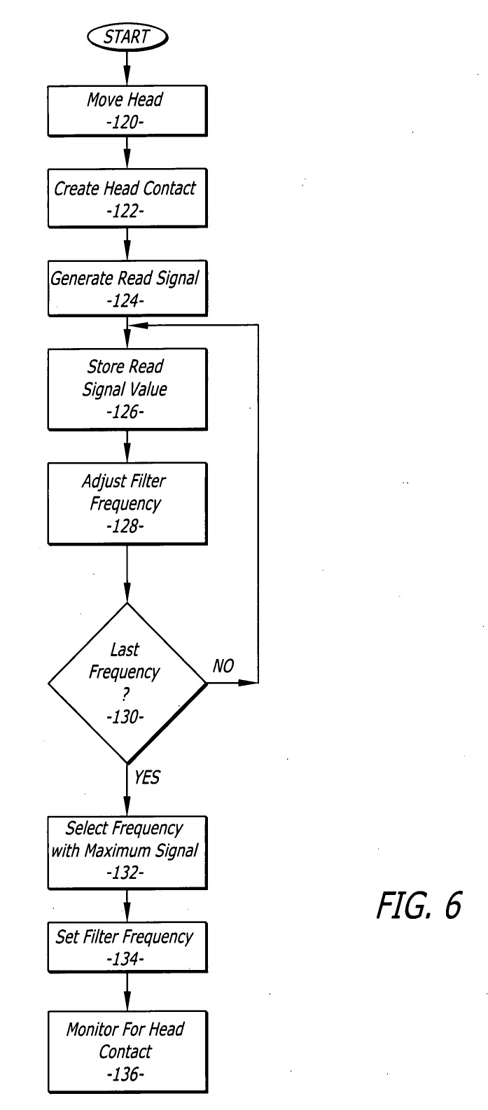

FIG. 6 is a flowchart showing a method for head contact detection and monitoring. In step 120 the head is moved across the disk in a seek routine. The heating element of a head is driven to create head/disk contact in step 122. The head generates a read signal that is provided to the band-pass filter in step 124. The value of the read signal is stored in memory in step 126. In step 128 the filter frequency is adjusted. In decision block 130 it is determined whether the process is at the last filter frequency setting. If so, a frequency with the maximum signal is selected in block 132 and the filter is set to that frequency in step 134. If not, the process returns to step 126.

In step 136, the subsequent output of the filter or amplitude detector can be monitored to detect head contact. This head contact can be monitored by the drive even during an off-track operation such as a seek routine. By way of example, the read signal can be monitored to detect and count the number of times the signal exceeds the threshold. A warning signal can be generated if the count exceeds a certain value within a predetermined time interval.

When a head contact is detected, the time, head number, gray code and operating conditions (eg. temperature) can be recorded and saved onto a dedicated track of the disk. An area of a disk that repeatedly creates head contact can cause the generation of a warning signal. The time, head number, gray code and operating condition data can be provided in a log for evaluation. The region with the highest density of track numbers is the region where head contact is most likely to occur.

A method can be implemented to determine whether head contact is created by an actuator movement profile or a head/disk interface. A seek routine can be initiated and head contact is detected while the heads move across different track ranges. The location of head contact is analyzed to determine whether a high contact region moves as a function of seek range. If the high contact region moves with different seek lengths, then the head contact is most likely caused by the seek profile. If the region does not move then the contact is caused by the head/disk interface. If the region disappears then head contact was most likely caused by the combination of the seek profile and head/disk interface.

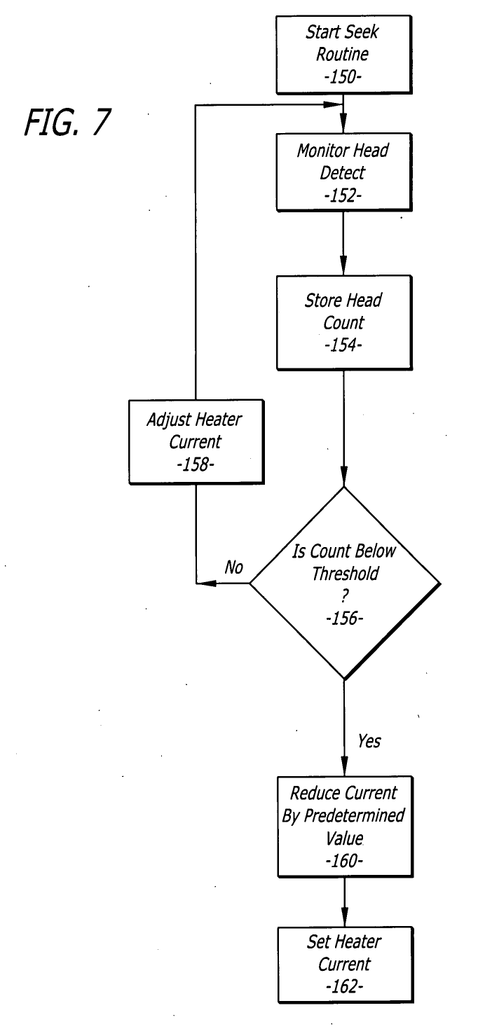

FIG. 7 is a method for setting a heater element of a fly on demand head. In step 150 a seek routine is initiated. Head contact is detected and counted in step 152. The head count is stored in step 154. In decision block 158 it is determined whether the count is below a threshold. If not, the heater current is adjusted and the process returns to block 152. If so, the current is reduced by a predetermined value in step 160 and set in step 162. The current can be reduced to move the set current value to a point below the threshold to further minimize head contact.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk;
a head coupled to said disk, said head having a read element and a heater element; and,
a circuit coupled to said head, said circuit moves said head relative to said disk in a seek routine and drives said heater element to cause contact between said head and said disk, said circuit determines a center frequency of a read signal provided by said head that corresponds to the head contact during said seek routine.

2. The disk drive of claim 1, wherein said circuit includes a band pass filter and an amplitude detector.

3. The disk drive of claim 2, wherein said center frequency is a frequency that has a maximum read signal.

4. The disk drive of claim 1, wherein an area of said disk that corresponds to the head contact is recorded and stored.

5. The disk drive of claim 1, wherein said head moves relative to said disk in a seek routine.

6. A hard disk drive, comprising:
a disk;
a head coupled to said disk, said head having a read element and a heater element; and,
circuit means for moving said head relative to said disk and driving said heater element to cause contact between said head and said disk, and for determining a center frequency of a read signal provided by said head that corresponds to the head contact during said seek routine.

7. The disk drive of claim 6, wherein said circuit means includes a band pass filter and an amplitude detector.

8. The disk drive of claim 7, wherein said center frequency is a frequency that has a maximum read signal.

9. The disk drive of claim 1, wherein an area of said disk that corresponds to the head contact is recorded and stored.

10. The disk drive of claim 1, wherein said head moves relative to said disk in a seek routine.

11. A program storage medium that contains a program for a hard disk drive, the hard disk drive having a head with a read element and a heater element, and a disk coupled to the head, comprising:
a program storage medium that contains a program which causes a circuit to move the head relative to the disk and drive the heater element to cause contact between the head and the disk, the program causes the circuit to determine a center frequency of a read signal provided by the head that corresponds to the head contact during the seek routine.

12. The medium of claim 11, wherein said center frequency is a frequency that has a maximum read signal.

13. The medium of claim 11, wherein an area of the disk that corresponds to the head contact is recorded and stored.

14. The medium of claim 11, wherein the head moves relative to said disk in a seek routine.

15. A method to detect contact between a head and a disk of a hard disk drive, comprising:
moving the head relative to the disk;
moving the head into contact with the disk by driving a heating element of the head;
filtering a read signal from the head through a band pass filter;
determining a frequency that produces a maximum read signal; and,
setting the determined frequency as a center frequency of the hand-pass filter.

16. The method of claim 15, further comprising monitoring contact between the head and the disk.

17. The method of claim 15, further comprising recording and storing an area of the disk that corresponds to the head contact.

18. The method of claim 15, wherein the head moves relative to the disk in a seek routine.
